(19) United States
(12) Patent Application Publication
(10) Pub. No.: US 2015/0332799 A1
(43) Pub. Date: Nov. 19, 2015

(54) METHODS AND APPARATUS FOR THE PRODUCTION OF ISOTOPES

(71) Applicant: ISO Evolutions, LLC, Oakwood, TX (US)

(72) Inventor: Matthew Fox Fritz, St. Marys, PA (US)

(21) Appl. No.: 14/681,835

(22) Filed: Apr. 8, 2015

Related U.S. Application Data
(60) Provisional application No. 61/994,301, filed on May 16, 2014.

(51) Int. Cl. G21G 1/00

(52) U.S. Cl. CPC G21G 1/00; G21G 1/001; G21G 2001/0036; G21G 2001/0042; G21G 2001/0094; G21G 2001/0068

(57) ABSTRACT

A method for producing an isotope of interest includes providing a target including a first isotope of a target element, and bombarding the target with accelerated ions to produce in the target by nuclear reactions between the accelerated ions and the first isotope of the target element: a second isotope of the target element, wherein the second isotope of the target element is the isotope of interest or a radioisotope within a decay chain of the isotope of interest; and transmutation products of a different elemental form than the target element.

### RELATED APPLICATIONS

The present application claims the benefit of and priority from U.S. Provisional Patent Application No. 61/994,301, filed May 16, 2014, the disclosure of which is incorporated herein by reference in its entirety.

### FIELD OF THE INVENTION

The present invention relates to isotopes and, more particularly, to methods and apparatus for producing isotopes.

### BACKGROUND OF THE INVENTION

Production of nuclear radioisotopes of interest for the commercial, academic, and medical fields has primarily been achieved through the fission of highly enriched uranium (hereinafter referred to as “HEU”) targets. Two or more radioisotopes result from the fission of the uranium-235 via thermal (low energy) neutrons. The amount of a certain radioisotope produced by the fission of uranium-235, or other fissile isotope, is directly proportional to the isotope to be fissioned (U-235, Pu-239, etc.) and the number of fissions that occur. The fission products are then separated by chemical or other means and the radioisotopes of interest are extracted.

The majority of radioisotope production has been performed using research reactors. These are often small reactors that fission HEU targets for the production of radioisotopes of interest. Declining public opinion regarding the nuclear industry, governmental regulatory requirements, and a limited supply of HEU have prevented the development of a dedicated fission based radioisotope production facility in the United States.

The invention and development of particle accelerators has led to the discovery of a number of new radioisotopes and their corresponding uses in commercial, academic, and medical applications. Particle accelerators producing radioisotopes are often used today to produce medical radioisotopes that cannot be viably transported over long distances due to the very short half lives of said radioisotopes. The high energies necessary to directly produce these short lived radioisotopes often require a large area for construction and operation, in addition to a cost proportional to the maximum energy of the particle accelerator.

The vast majority of radioisotopes of interest are produced by a small number of aging nuclear reactors across the world, many of which are nearing the end of their operating lifetime. Even if new research reactors were commissioned, it would be a significantly troublesome political task for one to earn the necessary governmental approval allowing HEU use. Adding to the problem of establishing a stable supply of radioisotopes are the increased worldwide nuclear proliferation efforts calling for reduction and eventual elimination of HEU, regardless of use.

### BRIEF DESCRIPTION OF THE DRAWINGS

FIG. 1 is a flowchart representing methods for producing isotopes according to embodiments of the invention.

FIG. 2 is a schematic diagram of a system for producing isotopes according to embodiments of the invention.

FIG. 3 is a schematic diagram representing a summation of production process reactions according to embodiments of the invention.

### SUMMARY OF THE INVENTION

According to embodiments of the invention, a method for producing an isotope of interest includes providing a target including a first isotope of a target element, and bombarding the target with accelerated ions to produce in the target by nuclear reactions between the accelerated ions and the first isotope of the target element: a second isotope of the target element, wherein the second isotope of the target element is the isotope of interest or a radioisotope within a decay chain of the isotope of interest; and transmutation products of a different elemental form than the target element.

According to embodiments of the invention, a system for producing an isotope of interest includes an ion source to emit ions, a particle accelerator, and a target including a first isotope of a target element. The system is configured such that the particle accelerator accelerates the ions emitted from the ion source to produce accelerated ions, and the accelerated ions bombard the target to produce in the target by nuclear reactions between the accelerated ions and the first isotope of the target element: a second isotope of the target element, wherein the second isotope of the target element is the isotope of interest or a radioisotope within a decay chain of the isotope of interest; and transmutation products of a different elemental form than the target element.

According to embodiments of the invention, an isotope is produced by the process of providing a target including a first isotope of a target element, and bombarding the target with accelerated ions to produce in the target by nuclear reactions between the accelerated ions and the first isotope of the target element: a second isotope of the target element, wherein the second isotope of the target element is the isotope of interest or a radioisotope within a decay chain of the isotope of interest; and transmutation products of a different elemental form than the target element.

Further features, advantages and details of the present invention will be appreciated by those of ordinary skill in the art from a reading of the figures and the detailed description of the preferred embodiments that follow, such description being merely illustrative of the present invention.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this disclosure and the relevant art and will not be interpreted in an idealized or overly formal sense unless expressly so defined herein.

As used herein, “monolithic” means an object that is a single, unitary piece formed or composed of a material without joints or seams.

As used herein, a “parent radioisotope” is a precursor radioisotope that decays through one or more radioactive decay processes or steps to a “daughter” isotope (stable isotope or radioisotope). The daughter isotope may be an immediate successor to the parent radioisotope or there may be one or more additional, intervening daughter radioisotopes in the decay chain (e.g., the parent radioisotope may be a grandparent radioisotope to the daughter isotope).

As used herein, “target isotope” refers to an elemental isotope forming a part of a target and that is bombarded to form from the target isotope an isotope of interest. The target may include one or constituent materials other than the target isotope. These other materials may include materials that are and/or are not isotopes of the same chemical element as the target isotope.

“Isotope production” refers to producing a desired isotope directly or a radioisotope lying within the decay chain of the desired isotope. “Radioisotope production” refers to such production of an isotope that is a radioisotope (i.e., a radioactive isotope).

“Transmutation reaction” refers to a nuclear reaction or nuclear reactions that result in generation or production of heavy ions/elements with a different proton number than the proton number of the desired isotope (or, depending upon the isotope production method and chemical extraction method, a proton number that is different from the radioisotope produced that lies within the decay chain of the desired radioisotope).

“Heavy ions” or “heavy elements” refers to ions or elements having a proton number greater than three (3), and a mass number greater than seven (7).

The present invention relates to novel systems, processes and methods for the production of isotopes (stable and radioactive) such as for medical, academic and commercial applications. Systems and methods according to embodiments of the present invention can overcome the disadvantages discussed above and can meet the recognized need by providing new and improved systems, processes and methods for the sustainable production of stable and radioactive isotopes.

In some embodiments, there is provided a method of high specific activity (amount of radioactivity per unit mass; e.g., Curies/gram) radioisotope production by simultaneous production and transmutation of a target material via exposure to a high current (>10 mA) beam of accelerated particles.

In some embodiments, there is provided a method of high specific activity radioisotope production wherein a high current particle accelerator accelerates charged particles to bombard a fixed location target (e.g., not a collider). Under bombardment of the charged particles by the accelerator, the radioisotope of interest and transmutation products are produced within the stationary target. The radioisotope of interest for production is of the same elemental form (same proton number) as that of the target. In addition to the radioisotope of interest, the target also undergoes a large number of transmutation reactions leaving a certain concentration of atoms in the target of different elemental form than that of the target prior to bombardment.

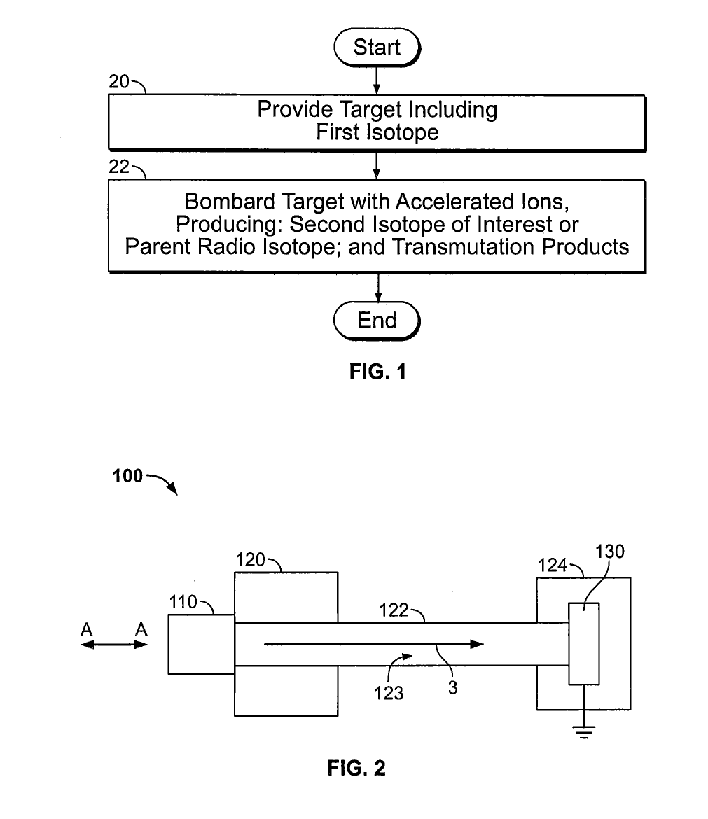

With reference to the flow chart of FIG. 1, methods of the present invention include providing a target including a first isotope of a target element (Block 20). The method further includes bombarding the target with accelerated ions to produce in the target by nuclear reactions between the accelerated ions and the first isotope of the target element, each of: a second isotope of the target element, wherein the second isotope of the target element is the isotope of interest or a radioisotope within a decay chain of the isotope of interest; and transmutation products of a different elemental form than the target element (Block 22). The method may further include separating the transmutation products from the isotope of interest in the irradiated target to form a processed target. In particular, the processed target so formed may be a high specific activity radioisotope of interest.

In some embodiments, the isotope of interest is a stable (i.e., nonradioactive) isotope. In some embodiments, the isotope of interest is a radioisotope.

With reference to FIG. 2, an isotope production system 100 according to embodiments of the invention is shown therein. The system 100 includes an ion source 110, a particle accelerator 120, a beam tube 122, and a target 130.

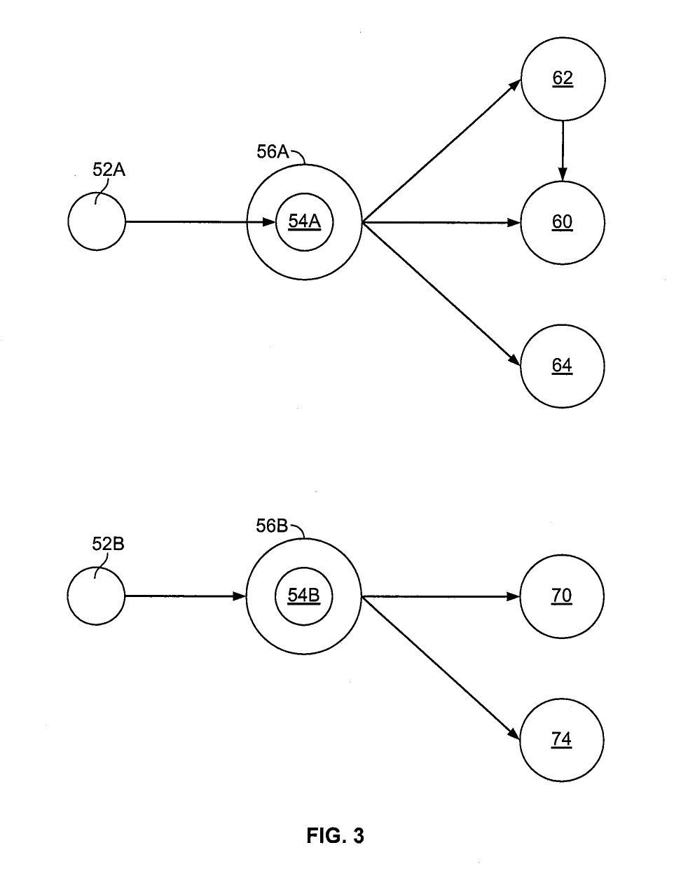

The target 130 includes a quantity of target isotope atoms 56 (FIG. 3). According to some embodiments, the concentration (naturally or enriched) of the target isotope 56 in the target is at least 10%. The target 130 may be electrically grounded, as shown. The target 130 may be contained in a target vacuum chamber 124.

The ion source 110 is in fluid communication with the particle accelerator 120 such that ions from the ion source 110 are directed, injected or otherwise travel into the particle accelerator 120. The particle accelerator 120 is in fluid communication with the target 130 through a passage 123 defined by the beam tube 122. The passage 123 contains a vacuum. The beam tube 122 may be formed of stainless steel or aluminum, for example.

In use, the ion source 110 produces ions, which are in turn accelerated to a desired particle energy by and within the particle accelerator 120. The particle accelerator directs the accelerated ions as an ion beam B through the beam tube passage 123 to strike or bombard the target 130. The ion beam B travels generally along a beam axis A-A toward the target 130 (i.e., in the direction indicated by the arrowhead of the schematically indicated ion beam B). The method may include irradiating or bombarding the target 139 with the accelerated ions by allowing the accelerated ions to flow into the target 130 with or without additional input or influence (e.g., focusing, bonding, further accelerating, splitting, etc.).

The collisions of the accelerated ions with the target 130 produce in the target 130 transmutation reaction products (via transmutation reactions) and production reaction products (via production reactions). More particularly, at least some of the accelerated ions collide with and are absorbed in the nucleus of the target isotope 56. The resulting transmutation reactions create transmutated atoms of a different elemental form (i.e., different proton number) than the target isotope 56. The resulting production reactions create an isotope or isotopes (herein referred to as production isotopes) of the same elemental form (i.e., same proton number) as the target isotope 56, but having a different atomic mass number than the target isotope (i.e., having different neutron number). The production isotope may be the isotope of interest or a radioisotope in the decay chain thereof. The transmutation reactions and production reactions also result in the emission of byproducts in the form of radiation and/or nucleons due to nucleic decay.

The production reaction by ion absorption may result in either the direct or indirect production of the isotope of interest in the target 130. That is, in some cases the isotope of interest (stable or radioactive) is formed directly by the accelerated ion irradiation/bombardment and, in other cases, a radioisotope (other than the isotope of interest) that lies within the decay chain of the desired isotope of interest is formed by the accelerated ion bombardment. The radioisotope will undergo radioactive transmutation, via single or multiple radioactive decays, before the desired isotope of interest is reached. The decay chain from the parent radioisotope to the daughter isotope of interest can include alpha, beta minus, beta plus, isomeric transition, or electron capture decay or a combination of one or more of these decay processes, for example.

In some embodiments, the isotope of interest is a stable (i.e., non-radioactive) isotope. In other embodiments, the isotope of interest is a radioisotope (i.e., radioactive or unstable isotope).

The isotope of interest and/or the transmutation reaction products can thereafter be harvested from the irradiated target 130 as needed. In some embodiments, the transmutation reaction products are separated from the remainder of the target 130 to form a processed target and, in some embodiments, a high specific activity radioisotope of interest. For example, the transmutation reaction products can be chemically separated from a remainder of the target 130. In some embodiments, the isotope of interest can be more efficiently and/or completely separated from the transmutation reaction products than from the target isotope or isotopes of the same elemental form as the target isotope. Other methods of removing the transmutation reaction products from the irradiated target or separating the transmutation reaction products from the isotope of interest (production isotopes) may include electromagnetic mass spectroscopy, atomic vapor laser isotope separation, molecular vapor laser isotope separations, gas centrifuge, or gaseous diffusion.

FIG. 3 schematically represents a summation of the nuclear reactions that occur within isotope production processes of the present invention. Two ions 52A and 52B are emitted from the ion source 11Q, accelerated or energized by the accelerator 120, and bombard the target 130. The target 130 includes first and second atoms 56A and 56B of the target isotope 56. The ion 52A is bombarded into a target nucleus 54A of the first target isotope atom 56A in the target 130. The ion 52A is absorbed by the target nucleus 54A resulting (via a production reaction) in either direct production of the isotope of interest 60 or direct production of a parent radioactive isotope 62 in the decay chain of the daughter isotope of interest 60. Additionally, one or more production reaction byproduct nucleon(s) 64 (e.g., single or multiple protons, neutrons, deuterons, tritons (³H), helions (³He), alpha particles (⁴He), lithium ions (⁶Li or ⁷Li)) is/are emitted from the target nucleus 54A. If the ion absorption results in the production of the parent radioactive isotope 62, the radioactive isotope 62 then experiences one or multiple alpha, beta minus, beta plus, isomeric transition, or electron capture decays, or combination of radioactive decays to arrive at the isotope of interest 60.

Referring again to FIG. 3, the ion 52B is bombarded into a target nucleus 54B of the second target isotope atom 56B in the target 130. The ion 52B is absorbed by the target nucleus 54B resulting (via a transmutation reaction) in production of a transmutated atom 70. Additionally, one or more transmutation reaction byproduct nucleon(s) 74 (e.g., single or multiple protons, neutrons, deuterons, tritons (³H), helions (³He), alpha particles (⁴He), lithium ions (⁶Li or ⁷Li)) is/are emitted from the target nucleus 54B. The transmutated atom 70 may likewise thereafter experience one or multiple alpha, beta minus, beta plus, isomeric transition, or electron capture decays, or combination of radioactive decays.

The ions produced by the ion source 110 and accelerated by the particle accelerator 120 may be negatively or positively charged ions.

In some embodiments, the ions produced by the ion source 110 and accelerated by the particle accelerator 12Q are positively charged light hydrogen ions (¹H⁺; i.e., protons) or negatively charged hydrogen ions (¹H⁺).

In some embodiments, the ions produced by the ion source 110 and accelerated by the particle accelerator 120 are positively charged heavy hydrogen ions (²H⁺; i.e., deuterons) or negatively charged heavy hydrogen ions.

In some embodiments, the ions produced by the ion source 110 and accelerated by the particle accelerator 120 are positively charged heavy hydrogen ions (³H⁺; i.e., tritons) or negatively charged heavy hydrogen ions.

In some embodiments, the ions produced by the ion source 110 and accelerated by the particle accelerator 120 are positively or negatively charged helium ions. In some embodiments, the ions produced by the ion source 110 are singly ionized helium ions (i.e., ⁴He⁺ ions including an alpha particle (α)) or doubly ionized helium ions (i.e., ⁴He⁺⁺ ions constituting an alpha particle). In some embodiments, the ions produced by the ion source 110 are ³He⁺ or ³He⁺⁺ ions.

In some embodiments, the target 130 is simultaneously or alternatingly bombarded with multiple species of accelerated ions (e.g., both protons and deuterons) to increase production or transmutation.

In some embodiments, the accelerated ion beam B has a maximum energy at or incident on the target 130 equal to or less than 50 MeV and more particularly, in some embodiments, in the range of from about 10 to 20 MeV.

In some embodiments, the accelerated ion beam B has a current of at least 10 mA, in some embodiments, at least 100 mA, and more particularly, in some embodiments, in the range of from about 100 mA to 5 A.

In some embodiments, the accelerated ion beam B has a beam size (i.e., area of irradiation or bombardment on the target 130) of less than area of the target and more particularly, in some embodiments, in the range of from about 80% to 100% of the target area.

In some embodiments, the particle accelerator 120 is operated pulsed mode. In some embodiments, the particle accelerator is operated in continuous wave mode.

The ion source 110 may be of any suitable type and construction to provide the desired ions to the accelerator 120. Suitable types of ion sources may include systems that create ions based upon electron impact ionization, RE coupling, or negative ion formation processes.

According to some embodiments, the ion source 110 is operated in a pulsed mode. According to some embodiments, the ion source 110 is operated with a duty cycle of at least 0.1.

According to some embodiments, the ion source 110 provides the ions to the particle accelerator 120 at a current of at least 10 mA and, in some embodiments, at a current in the range of from about 100 mA to 5 A.

The particle accelerator 120 may be of any suitable type and construction. According to some embodiments, the accelerator 120 is a single ended or tandem electrostatic particle accelerator.

According to some embodiments, the accelerator 120 is an induced alternating electric or magnetic field particle accelerator.

According to some embodiments, the accelerator 120 is a low energy particle accelerator having a maximum particle energy (i.e., of the accelerated ions at the target 130; E_{Max}) of less than 50 MeV and, in some embodiments, in the range of from about 10 to 20 MeV.

The composition and structure of the target 130 may depend on the type of the bombarding ions, the configuration of the system and other operational parameters.

The target 130 may be composed of any suitable material(s) that is/are convertible directly or indirectly by ion absorption into the isotope(s) of interest. The target 130 may be formed of a composition including the target isotope 56 or may be formed of pure isotope material 56. According to some embodiments, the target 130 is formed of a target isotope material 56 selected from the group consisting of ⁹⁸Mo, ⁵⁹Co, ¹³²Xe, ¹⁹¹Ir, ¹²⁴Xe. It will be appreciated that the target 130 may include a material or materials different from and additional to the target isotope material 56. According to some embodiments, the target 130 is naturally constituted with or enriched to at least 10% concentration of the target isotope material 56 and, in some embodiments, at least 95% concentration.

As discussed above, the isotope of interest may be produced directly in the target 130 by the ion bombardment. In this case, in some embodiments, the isotope of interest is a radioisotope selected from the group consisting of ⁹⁹Mo, ⁶⁰Co, ¹³³Xe, ¹⁹²Ir.

However, these listings are not exclusive and other directly produced isotopes of interest may be produced as desired.

As discussed above, the isotope produced in the target 130 by the ion bombardment may be a parent radioisotope in the decay chain of the isotope of interest (the daughter isotope, which may be stable or radioactive). In this case, in some embodiments, said parent radioisotope is ¹²⁵Xe. However, other radioisotopes may be produced as desired. According to some embodiments, the daughter radioisotope of interest is ¹²⁵I.

In some embodiments, the target 130 is solid. However, the target 130 may alternatively be of or in liquid, gaseous, or plasma state. The target 130 may be elementally pure or in compound form. The target 130 may be enriched or a natural isotopic composition. The target 130 may be presented in a solid powder form, in which case the target may be vacuum packed in order to remove gas present between powder particulates. If the target is provided in a liquid or gaseous state, it may be pressurized above atmospheric pressure or maintained at atmospheric pressure. In some embodiments, the target 130 is in a solid, liquid, gas or plasma state and is maintained at a pressure of at least 1 atm during the ion bombardment.

The target may be doped or mixed with additional elements/isotopes additional to the target isotope 56 to increase and/or balance the transmutation rate of the target material.

The target 130 may have any suitable shape, such as disk shaped.

Due to the heat that is generated within the target 130 by the bombarding ions, the target 130 may be cooled via water, other liquid coolant, cooling gas, or other suitable cooling agent. In some embodiments, the target 130 is actively cooled by a circulated cooling fluid.

Multiple targets may be used per production run. These targets may be changed via an automated or gravity driven system or manually removed from the system and replaced with a new, unirradiated target. The use of a beam splitter, multiple beam tubes, beam bending and directing magnets, and multiple targets may also be employed in order to lengthen the use of the targets.

The target 130 may be packaged or partitioned in a fashion beneficial to radiochemical extraction/processing whether it is to occur during the isotope production process or after the completion of isotope production.

The parameters of target material, target composition, target isotopic enrichment, target density, target geometry, and particle accelerator beam current can be varied. According to some embodiments, the process parameters, reactions and products will meet the following conditions:

$$Specific Activity Specification [ \frac{Ci}{g} ] = \frac{( Radioisotope of Interest Activity [ Ci ] )}{[ \begin{matrix}( Radioisotope of Interest Atoms + \\ ( γ ( Transmutated Atoms ) + Unreacted Atoms ) * ( \frac{M}{{N}_{A}} )\end{matrix} ]}$$

$$Specific Activity Specification [ \frac{Ci}{g} ] = \frac{{λ}_{ROI} {N}_{ROI} {e}^{- {λ}_{ROI} {t}_{Separation}}}{[ ( {N}_{ROI} + ( γ {N}_{Trans} ) + {N}_{Unreact} ) \frac{M}{{N}_{A}}}$$

### Where:

λ_{ROI}=Decay constant of the radioisotope of interest;
N_{ROI}=Number of radioisotope of interest atoms within the target at the end of irradiation by accelerator;
t_{Separation}=time taken for chemical separation of transmutation products;
y=(1−Chemical separation efficiency of transmutation products);
N_{Trans}=Number of transmutated atoms within the target at the end of irradiation;
N_{Unreact}=(Original number of atoms in target−(Radioisotope of interest atoms in target+transmutated atoms in target))−Number of atoms that have not been transmutated nor produced an ROI atom;
M=Molar mass of target (pre-irradiation); and
N_{A}=Avogadro's number.

The number of radioisotope of interest atoms and number of transmutation atoms can be calculated via the Robinson equations:

$${N}_{n} = {C}_{1} {e}^{- {A}_{1} t} + {C}_{2} {e}^{- {A}_{2} t} + … + {C}_{n} {e}^{- {A}_{n} t}$$

$${C}_{1} = \frac{{Λ}_{1}^{*} {Λ}_{2}^{*} … {Λ}_{n - 1}^{*}}{( {Λ}_{2} - {Λ}_{1} ) ( {Λ}_{3} - {Λ}_{1} ) … ( {Λ}_{n} - {Λ}_{1} )} {N}_{1}^{0}$$

$${C}_{2} = \frac{{Λ}_{1}^{*} {Λ}_{2}^{*} … {Λ}_{n - 1}^{*}}{( {Λ}_{1} - {Λ}_{2} ) ( {Λ}_{3} - {Λ}_{2} ) … ( {Λ}_{n} - {Λ}_{2} )} {N}_{1}^{0}$$

$${Λ}_{n}^{*} = {σ}_{n} * φ$$

$${Λ}_{n} = ( {λ}_{n} + {σ}_{n} φ )$$

When applied to the radioisotope of interest, N_{ROI} can be calculated as follows:

$${N}_{ROI} = {σ}_{ROI} φ {N}_{Target} ( \frac{{e}^{- {Λ}_{Target} t}}{( {Λ}_{ROI} - {Λ}_{Target} )} + \frac{{e}^{- {Λ}_{ROI} t}}{( {Λ}_{Target} - {Λ}_{ROI} )} )$$

### Where:

N_{Target}=Number of atoms in the target that can produce atoms of ROI via reaction with accelerated charged particle beam;
Λ_{ROI}=λ_{ROI}(s⁻¹)+σ_{Loss}(cm²)*φ(#/cm²/s);
Λ_{Target}=σ_{ROI}(cm²)*φ(#/cm²/s);
σ_{ROI}=Microscopic nuclear cross section for ROI production (cm²);
σ_{Loss}=Microscopic nuclear cross section for loss of ROI atoms already produced (cm²); and
φ=Charged particle flux (#/cm²/s).

When applied to the transmutation products, N_{Trans} can be calculated as follows:

$${N}_{Trans} = φ {N}_{Target} {\sum }_{i = 1}^{∞} {σ}_{Trans}^{i} ( \frac{{e}^{- {Λ}_{Target}^{i} t}}{( {Λ}_{Trans}^{i} - {Λ}_{Target}^{i} )} + \frac{{e}^{- {Λ}_{Trans}^{i} t}}{( {Λ}_{Target}^{i} - {Λ}_{Trans}^{i} )} )$$

### Where:

N_{Target}=Number of atoms in the target that can produce atoms of ROI via reaction with accelerated charged particle beam;
Λ_{Trans}ⁱ=λ_{Trans}ⁱ(s⁻¹)+σ_{Replacement}ⁱ(cm²)*φ(#/cm²/s);
Λ_{Target}ⁱ=σ_{Trans}ⁱ(cm²)*φ(#/cm²/s);
σ_{Trans}ⁱ=Microscopic nuclear cross section for the individual transmutation product (cm²);
σ_{Replacement}ⁱ=Individual microscopic nuclear cross section for the reactions resulting in previously transmutated atoms back into the original elemental form/same elemental form as target (cm²); and
φ=Charged particle flux (#/cm²/s).

According to some embodiments, a method of producing an isotope of interest as described above is configured and executed to produce Molybdenum-99 (Mo-99) as the isotope of interest. The target includes Molybdenum-98 (Mo-98) as the target isotope and, according to some embodiments, the target is enriched to a Mo-98 concentration of at least 95% and, in some embodiments, at least 98%. The accelerated ions are deuterons (²H). In some embodiments, the accelerated ions have an ion energy of at least about 10 MeV and, in some embodiments, in the range of from about 10 to 20 MeV. This process will create production reactions and transmutations in the enriched Mo-98 target as described above to generate Mo-99 as the production isotope and isotopes of technetium (Tc-97, Tc-98, and Tc-99) as transmutated atoms. More particularly the ion bombardment causes production and transmutation reactions as follows:

Production Reaction:

⁹⁸Mo+²H→⁹⁹Mo+¹H
(Microscopic cross-section at 15 MeV: σ=43.4 mb (millibarns))

Transmutation Reactions:

⁹⁸Mo+²H→⁹⁹Tc+¹n
(Microscopic cross-section at 15 MeV: σ=20.4 mb);

⁹⁸Mo+²H→⁹⁸Tc+2(¹n)
(Microscopic cross-section at 15 MeV: σ=949.5 mb); and

⁹⁸Mo+²H→⁹⁷Tc+3(¹n)
(Microscopic cross-section at 15 MeV: σ=344.3 mb).

Following the bombardment and nuclear reaction step, the technetium transmutated atoms are separated (e.g., chemically) from the molybdenum isotopes of the irradiated target.

Using the exemplary or expected microscopic cross-sections as listed above, the ratio of transmutated atoms to production isotopes produced can be calculated as follows:

$$Transmutation to Production Ratio = \frac{Transmuation}{Mo \text{-} 99 Production} = \frac{20.4 mb + 949.5 mb + 344.3 mb}{43.4 mb} = 30.3$$

Standard chemical isotope separation methods can remove technetium isotopes from the molybdenum isotopes, but cannot remove the individual molybdenum isotopes from each other (i.e., ⁹⁹Mo cannot be separated from ⁹⁸Mo). To illustrate this, assume that the specification for the ratio of Mo-99 to other molybdenum isotopes in the mixture is 0.15 (15%) and compare the inventive Mo-99 production technique (hereinbelow, “Ion Bombardment Method”) described above and the conventional method of Mo-99 production using neutron irradiation in a nuclear reactor (hereinbelow, “Neutron Irradiation Method”). The Neutron Irradiation Method generates Mo-99 by the following reaction:

⁹⁸Mo+¹n→⁹⁹Mo

The Ion Bombardment Method and the Neutron Irradiation Method can each produce 1.79×10²⁰ atoms of Mo-99 in the target. In one (1) gram of 100% enriched ⁹⁸Mo there are 6.14×10²¹ atoms. Therefore, the percentage of Mo-99 atoms produced in a target by each method can be calculated as follows:

$$Neutron Irradiation Method \text{:} \frac{1.79 E 20 atoms Mo \text{-} 99}{6.14 E 21 atoms in target} = 0.0292$$

$$Ion Bombardment Method \text{:} \frac{1.79 E 20 atoms Mo \text{-} 99}{6.14 E 21 atoms in target} = 0.0292$$

Neither of these methods can meet the required specification on their own. But when accounting for the transmutation of molybdenum atoms into technetium atoms and assuming a chemical separation efficiency of 99.9% (typical for many processes) of technetium from the remainder of the irradiated target, an end product meeting the desired specification is readily obtainable with known and available separation techniques. This potential is demonstrated by the following exemplary calculations:

$$Number of transmutated atoms = [ \# of Mo \text{-} 99 atoms in target ] \times [ Transmutation to production ratio ] = [ 1.79 \times {10}^{20} atoms Mo \text{-} 99 ] \times [ 30.3 ] = 5.42 \times {10}^{21} atoms$$

$$Mo \text{-} 99 to Mo \text{-} 99 Ratio [ after transmutated atom removal step ] = \frac{1.79 E 20 atoms Mo \text{-} 99}{6.14 E 21 atoms in target - 5.42 E 21 removal atoms} = 0.25$$

Thus, the exemplary Mo-99 production method according to embodiments of the invention can provide an end product with an Mo-99:Mo-98 ratio of 25%, which is well in excess of the specification of 15%. By contrast, the Neutron Irradiation Method cannot because the current chemical separation processes cannot separate the Mo-98 from Mo-99.

According to particular embodiments of the invention, the system 100 is configured and operated such that: the ion source 110 produces positively or negatively charged ²H ions with a current of at least 100 mA; the ions are accelerated using a single-ended or tandem electrostatic accelerator 120; the ²H ions have a maximum deuteron energy of less than or equal to 50 MeV when reaching the target 130; the target 130 is solid and enriched to at least 95% Mo-98; and the target 130 is actively cooled (e.g., with water or liquid nitrogen).

According to further embodiments, a method of producing an isotope of interest as described above is configured and executed to produce Cobalt-60 (Co-60) as the isotope of interest. The target includes Cobalt-59 (Co-59) as the target isotope and, according to some embodiments, has a Co-59 concentration of substantially 100%. The accelerated ions are deuterons (²H). In some embodiments, the accelerated ions have an ion energy of at least about 10 MeV and, in some embodiments, in the range of from about 10 to 20 MeV. This process will create production reactions and transmutations in the Co-59 of the target as described above to generate Co-60 as production isotopes, and isotopes of nickel and iron (Ni-60, Ni-59, Fe-59, Fe-57, and Fe-56) as transmutated atoms. More particularly the ion bombardment causes production and transmutation reactions as follows:

Production Reaction:

⁵⁹Co+²H→⁶⁰Co+¹H

Transmutation Reactions:

⁵⁹Co+²H→⁶⁰Ni+¹n

⁵⁹Co+²H→⁵⁹Ni+2(¹n)

⁵⁹Co+²H→⁵⁹Fe+2(¹H)

⁵⁹Co+²H→⁵⁷Fe+2(¹H)+2(¹n)*

⁵⁹Co+²H→⁵⁶Fe+2(¹H)+3(¹n)*

* Transmutation byproducts may be in a different particle format than described (e.g., deuteron instead of independent proton and neutron), and the above are only a presented total of total amount of protons and neutrons included in the transmutation byproducts.

According to further embodiments, a method of producing an isotope of interest as described above is configured and executed to produce Xenon-133 (Xe-133) as the isotope of interest. The target includes Xenon-132 (Xe-132) as the target isotope and, according to some embodiments, has a Xe-132 concentration of at least 27% and, in some embodiments, at least 90%. The accelerated ions are deuterons (²H). In some embodiments, the accelerated ions have an ion energy of at least about 10 MeV and, in some embodiments, in the range of from about 10 to 20 MeV. This process will create production reactions and transmutations in the Xe-132 of the target as described above to generate Xe-133 as production isotopes, and isotopes of cesium and iodine (Cs-133, Cs-132, Cs-131, and I-130) as transmutated atoms. More particularly the ion bombardment causes production and transmutation reactions as follows:

Production Reaction:

¹³²Xe+²H→¹³³Xe+¹H

Transmutation Reactions:

¹³²Xe+²H→¹³³Cs+¹n

¹³²Xe+²H→¹³²Cs+2(¹n)

¹³²Xe+²H→¹³¹Cs+3(¹n)

¹³²Xe+²H→¹³⁰I+2(¹H)+2(¹n)*

* Transmutation byproducts may be in a different particle format than described (e.g., deuteron instead of independent proton and neutron), and the above are only a presented total of total amount of protons and neutrons included in the transmutation byproducts.

According to further embodiments, a method of producing an isotope of interest as described above is configured and executed to produce Xenon-125 (Xe-125, which is a parent radioisotope of I-125) as the isotope of interest. The target includes Xenon-124 (Xe-124) as the target isotope and, according to some embodiments, has a Xe-124 concentration of at least 10% and, in some embodiments, at least 90%. The accelerated ions are deuterons (²H). In some embodiments, the accelerated ions have an ion energy of at least about 10 MeV and, in some embodiments, in the range of from about 10 to 20 MeV. This process will create production reactions and transmutations in the Xe-124 of the target as described above to generate Xe-125 as production isotopes, and isotopes of cesium and iodine (Cs-125, Cs-124, and I-122) as transmutated atoms. More particularly the ion bombardment causes production and transmutation reactions as follows:

Production Reaction:

¹²⁴Xe+²H→¹²⁵Xe+¹H

Transmutation Reactions:

¹²⁴Xe+²H→¹²⁵Cs+¹n

¹²⁴Xe+²H→¹²⁴Cs+2(¹n)

¹²⁴Xe+²H→¹²²I+2(¹H)+2(¹n)*

* Transmutation byproducts may be in a different particle format than described (e.g., deuteron instead of independent proton and neutron), and the above are only a presented total of total amount of protons and neutrons included in the transmutation byproducts.

According to further embodiments, a method of producing an isotope of interest as described above is configured and executed to produce Iridium-192 (Ir-192) as the isotope of interest. The target includes Iridium-191 (Ir-191) as the target isotope and, according to some embodiments, has an Ir-191 concentration of at least 37.3% and, in some embodiments, at least 90%. The accelerated ions are deuterons (²H). In some embodiments, the accelerated ions have an ion energy of at least about 10 MeV and, in some embodiments, in the range of from about 10 to 20 MeV. This process will create production reactions and transmutations in the Ir-191 of the target as described above to generate Ir-192 as production isotopes, and isotopes of platinum (Pt-192, Pt-191, Pt-190) as transmutated atoms. More particularly the ion bombardment causes production and transmutation reactions as follows:

Production Reaction:

¹⁹¹Ir+²H→¹⁹²Ir+¹H

Transmutation Reactions:

¹⁹¹Ir+²H→¹⁹²Pt+¹n

¹⁹¹Ir+²H→¹⁹¹Pt+2(¹n)

¹⁹¹Ir+²H→¹⁹⁰Pt+3(¹n)

Methods and systems for producing an isotope of interest as disclosed herein can provide a number of advantages. Quantities of the isotope of interest having high specific activity can be produced more efficiently and quickly. Significantly less process material may be required. Standard radiochemical separation techniques can be used to remove the transmutation products from the post-bombardment target.

According to same embodiments, isotope of interest end products formed by a process as disclosed herein (e.g., the high specific activity radioisotope of interest) have a specific activity of at least 1000 Curies/gram for the isotope of interest. According to some embodiments, the isotope of interest of the end product is Mo-99.

According to some embodiments, the high specific activity radioisotope of interest produced according to a process of the present invention is used directly as a radiopharmaceutical, as a bulk component of a radioisotope generator that is used for the production of multiple radiopharmaceuticals, and/or as the active component in sealed or unsealed radioactive sources such as those used for cancer treatment or food irradiation.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

That which is claimed is:

1. A method for producing an isotope of interest, the method comprising:
providing a target including a first isotope of a target element; and
bombarding the target with accelerated ions to produce in the target by nuclear reactions between the accelerated ions and the first isotope of the target element:
a second isotope of the target element, wherein the second isotope of the target element is the isotope of interest or a radioisotope within a decay chain of the isotope of interest; and
transmutation products of a different elemental form than the target element.

2. The method of claim 1 including, following the step of bombarding the target with the accelerated ions, removing the transmutation products from the target.

3. The method of claim 2 wherein removing the transmutation products from the target includes chemically removing the transmutation products from the target.

4. The method of claim 1 wherein the accelerated ions have an ion energy of at least about 10 MeV.

5. The method of claim 1 wherein the accelerated ions form a beam bombarding the target at a rate in the range of from about 10 mA to 5 A.

6. The method of claim 1 wherein the accelerated ions bombarding the target have a maximum energy in the range of from about 10 to 50 MeV.

7. The method of claim 1 wherein the isotope of interest is a radioisotope.

8. The method of claim 1 wherein the first isotope of the target element is Mo-98 and the isotope of interest is Mo-99.

9. The method of claim 8 wherein the target is Mo-98 target enriched to at least 95 percent Mo-98.

10. The method of claim 8 wherein the transmutation products include Tc-97, Tc-98, and Tc-99.

11. The method of claim 8 wherein the accelerated ions are deuterons.

12. The method of claim 1 wherein the first isotope of the target element is Co-59 and the isotope of interest is Co-60.

13. The method of claim 12 wherein the transmutation products include Ni-60, Ni-59, Fe-59, Fe-57 and Fe-56.

14. The method of claim 1 wherein the first isotope of the target element is Xe-132 and the isotope of interest is Xe-133.

15. The method of claim 14 wherein the transmutation products include Cs-133, Cs-132, Cs-131 and I-130.

16. The method of claim 1 wherein the first isotope of the target element is Xe-124 and the isotope of interest is Xe-125.

17. The method of claim 16 wherein the transmutation products include Cs-125, Cs-124 and I-122.

18. The method of claim 1 wherein the first isotope of the target element is Ir-191 and the isotope of interest is Ir-192.

19. The method of claim 18 wherein the transmutation products include Pt-192, Pt-191 and Pt-190.

20. The method of claim 2 wherein:
the method produces a high specific activity radioisotope of interest; and includes, following the step of removing the transmutation products from the target, using the high specific activity radioisotope of interest directly as a radiopharmaceutical, as a bulk component of a radioisotope generator that is used for the production of multiple radiopharmaceuticals, and/or as an active component in sealed or unsealed radioactive sources.

21. A system for producing an isotope of interest, the system comprising:
an ion source to emit ions;
a particle accelerator; and
a target including a first isotope of a target element;
wherein the system is configured such that:
the particle accelerator accelerates the ions emitted from the ion source to produce accelerated ions;
the accelerated ions bombard the target to produce in the target by nuclear reactions between the accelerated ions and the first isotope of the target element:
a second isotope of the target element, wherein the second isotope of the target element is the isotope of interest or a radioisotope within a decay chain of the isotope of interest; and
transmutation products of a different elemental form than the target element.

22. An isotope produced by the process of:
providing a target including a first isotope of a target element; and
bombarding the target with accelerated ions to produce in the target by nuclear reactions between the accelerated ions and the first isotope of the target element:
a second isotope of the target element, wherein the second isotope of the target element is the isotope of interest or a radioisotope within a decay chain of the isotope of interest; and
transmutation products of a different elemental form than the target element.
